(19) United States
(12) Patent Application Publication
(10) Pub. No.: US 2014/0363118 A1
(43) Pub. Date: Dec. 11, 2014

(54) MICROFIBER DEVICE WITH ENCLOSED INNER CAVITY

(71) Applicant: The Hong Kong Polytechnic University, Hong Kong (HK)

(72) Inventors: Dongning WANG, Hong Kong (HK); Changrui LIAO, Hong Kong (HK)

(21) Appl. No.: 13/912,216

(22) Filed: Jun. 7, 2013

(51) Int. Cl. G02B 6/26; G02B 6/255

(52) U.S. Cl. CPC G02B 6/262; G02B 6/2552
USPC 385/12; 65/392

(57) ABSTRACT

Photonic devices that include in-line optical microfibers for different uses such as sensing are described. At least one enclosed cavity is positioned within the optical microfiber. One or more enclosed cavities are positioned along or adjacent to a central axis of the microfiber. Light travelling within the microfiber passes through both the enclosed cavity and a remaining portion of the microfiber not occupied by the enclosed cavity. For interferometer applications, recombination of the light propagating through the microfiber and cavity has a light intensity correlated to an external physical property to be measured such as temperature and refractive index as well as strain and bending experienced by the fiber. Plural cavities can be constructed sequentially. Further, whispering gallery mode (WGM) resonator properties of the enclosed cavity can be used to measure external properties. A method for fabricating the optical microfiber devices by micromachining is also described.

### FIELD OF THE INVENTION

The present invention relates to optical fiber devices and, more particularly, to optical microfiber devices including at least one inner enclosed cavity within the microfiber.

### BACKGROUND OF THE INVENTION

Various types of optical fiber devices and components have emerged for a wide range of optical fiber communication and sensor applications. To improve optical fiber system simplicity and efficiency as well as reducing cost, it is desirable to have a versatile fiber in-line device that is easily integrated into a fiber-based system and is capable of performing multiple functions. Current fiber in-line devices include fiber gratings, photonic crystal fibers (PCF), and microfibers. Fiber gratings, including fiber Bragg gratings (FBG) and long period fiber gratings (LPFG), are typically formed by introducing a periodic refractive index (RI) or geometric structure modulation in a small section of the fiber length. Since its resonant wavelength is determined by the grating period and the effective RI of the fiber, which can be adjusted by various means such as strain, temperature, and RI of the surrounding medium, many communication and sensing functions can be achieved using fiber gratings. PCFs exhibit a periodic microstructure along the whole fiber length, which enables a different light guiding mechanism than conventional optical fibers. Microfibers have a small size but a large evanescent field for the guided light, which makes them sensitive to a surrounding medium.

However, there is a need in the art for structure which can perform multiple functions and operate in a variety of optical modes. Such structures could be used for improved multifunction optical sensors having enhanced sensitivity.

### SUMMARY OF THE INVENTION

The present invention provides photonic devices that include in-line microfiber optical fiber sensors. An exemplary enclosed cavity is positioned completely within the optical microfiber. An input light beam travelling within the optical fiber is split into two portions and passes through both the enclosed cavity and a remaining portion of the optical fiber that is not occupied by the enclosed cavity. The recombination of the two portions of light that propagate through the remaining portion of the optical fiber and through the cavity has a light intensity that can be related to an external factor such as temperature or surrounding refractive index. Alternatively, the combined spectrum can be related to strain or bend within the microfiber and the device can be used to sense changes in refractive index, temperature, strain and bending.

Strain can further be measured using the whispering gallery mode (WGM) resonator properties of the cavity and a second optical fiber carrying light that is evanescently coupled into the cavity followed by spectral analysis.

The microfiber optical fiber device is fabricated by providing a first optical fiber having a cladding layer and a core layer and cleaving the first optical fiber to expose an end surface. Micromachining by femtosecond (fs) laser ablation forms one or more micro-hole(s) positioned on the exposed end surface of the first optical fiber. A second optical fiber is cleaved to expose an end surface and the end surface of the first optical fiber having the microhole formed therein is fused to the end surface of the second optical fiber. The fused structure is heated and drawn to form a microfiber region having a diameter on the order of microns in the narrowed waist region. Within the microfiber region is an elongated cavity formed from the microhole micromachined in the first optical fiber. Depending on the application of the device, more than one cavity can be formed within one optical fiber by varying the operational parameters of the fs laser. The position of said cavity can also be varied to be positioned along a central axis or off-center with respect to a central axis of the formed microfiber, the position being determined by the position of the micromachining at the exposed end surface of the optical fiber.

### BRIEF DESCRIPTION OF THE DRAWINGS

FIG. 1 depicts a cavity positioned in a microfiber according to an exemplary embodiment of the present invention.

FIGS. 2(a)-2(d) schematically depict a method of fabricating a microfiber with a cavity according to an embodiment of the present invention.

FIG. 3(a) depicts a photomicrograph of a micro-hole fabricated by fs laser ablation at the center of a cleaved single mode fiber end facet.

FIG. 3(b) shows a hollow sphere formed after fusion splicing.

FIG. 3(c) is an SEM image of a cross section of the hollow sphere of FIG. 2(c)

FIG. 3(d) depicts a microfiber with an inner air-cavity. Inset is the cross section view of the microfiber.

FIG. 4(a) is a photomicrograph of an optical device used in refractive index measurement.

FIG. 4(b) depicts a transmission spectra evolution with external refractive index.

FIG. 4(c) shows the variation of dip wavelength with refractive index.

FIG. 4(d) is a photomicrograph of an optical device used in axial strain measurement.

FIG. 4(e) is a transmission spectra evolution with axial strain.

FIG. 4(f) depicts the variation of dip wavelength with axial strain.

FIG. 4(g) is a photomicrograph of an optical device used in high temperature measurement.

FIG. 4(h) is a transmission spectra evolution with ambient temperature.

FIG. 4(i) depicts the variation of dip wavelength with temperature.

FIG. 4(j) is a photomicrograph of an optical device used in bend measurement.

FIG. 4(k) is a transmission spectra evolution with curvature ratio between 0.4 and 2.1 m⁻¹.

FIG. 4(l) depicts the variation of dip wavelength with curvature.

FIG. 5(a) depicts a two-fiber system based on a microfiber with inner air-cavity.

FIG. 5(b) shows spectra evolution with axial strain.

FIG. 5(c) depicts the variation of dip wavelength with increasing strain.

FIG. 6(a) depicts an optical microfiber having two inner air-cavities formed in the fusion splicing with another cleaved SMF.

FIG. 6(b) is a side view of waist region of the microfiber with two inner air-cavities.

FIG. 6(c) is a cross-sectional view of the morphology of waist region of the microfiber with two inner air-cavities.

FIG. 6(d) is the measurement of polarization dependent loss (PDL) of the microfiber device at different wavelengths.

FIG. 7(a) is a cross-sectional view of the microfiber with a deviated air-cavity.

FIG. 7(b) is a cross-sectional view of the microfiber with three symmetrical air-cavities.

FIG. 7(c) is a photomicrograph showing cascaded microfibers with multiple inner air-cavities.

### DETAILED DESCRIPTION OF THE INVENTION

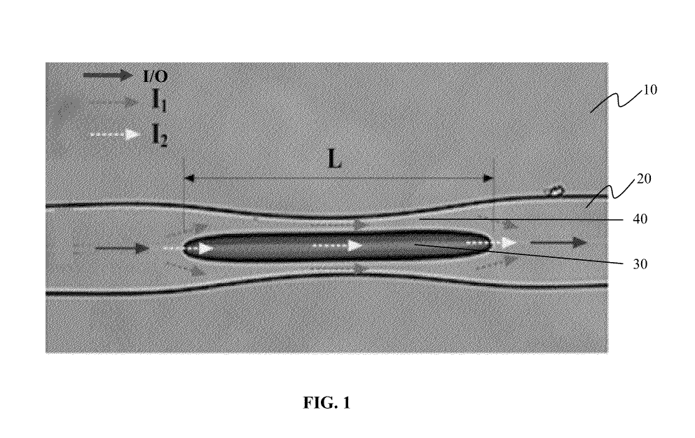

Turning to the drawings in detail, FIG. 1 schematically depicts an optical device 10 formed according to the present invention. Optical microfiber 20 encloses a cavity 30 positioned within microfiber 40. When light is lunched into the device, it is split into two beams: one passes through the inner cavity and the other travels along the silica wall of the cavity before recombining at the end of the microfiber. Input light beam I is partitioned into and Iᵢₙ₁ and Iᵢₙ₂; light passes through the cavity having a length L while Iᵢₙ₂ passes through the remaining portion of the microfiber 40 not taken up by cavity 30. The output light Iₒᵤₜ₁ is phase shifted from Iₒᵤₜ₂ due to the difference in light speed in the cavity versus the microfiber resulting in constructive or destructive interference of the combined output light O. Compared to a conventional microfiber of similar size, the thinner cavity wall of the present invention leads to a large evanescent field in one portion of the device and hence the enhanced light interaction with the surrounding medium.

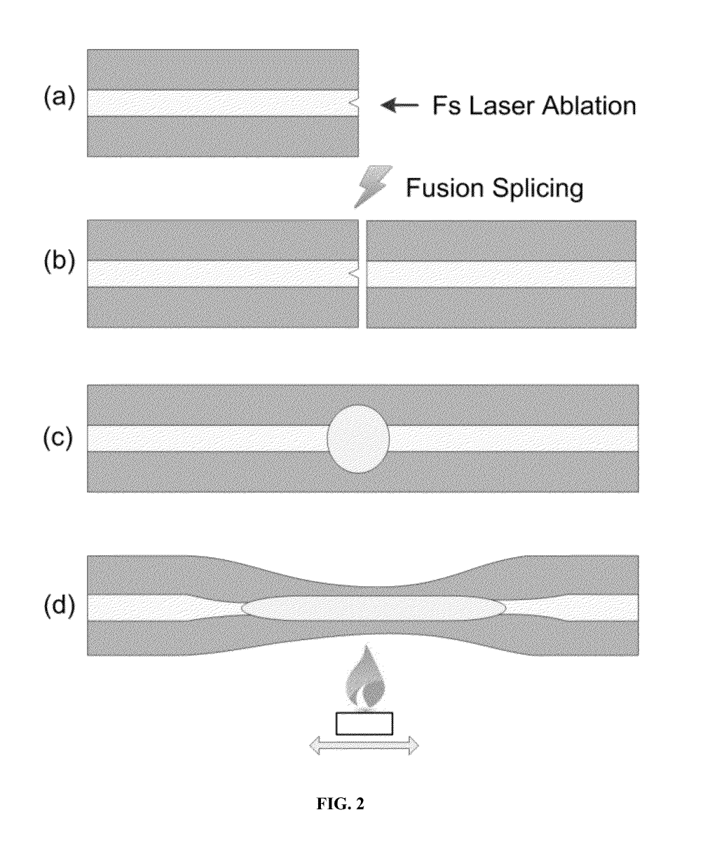

FIG. 2 schematically depicts the formation of the optical device 10 of FIG. 1. In FIG. 2(a), a femtosecond laser with pulse duration of about 120 fs, repetition rate of 1 kHz and operation wavelength of 800 nm is used. The laser pulses are focused onto the fiber by a 20× objective lens with an NA value of 0.5. A standard SMF-28 fiber (from Corning) with the core diameter of 8.2 microns and the nominal effective index of 1.4682 (at 1,550 nm) is mounted on a computer controlled X-Y-Z translation stage with a 40-nm resolution. The fabrication process includes a number of steps, as illustrated below as an example:
(a) A micro-hole of several microns in diameter at the center of cleaved fiber end facet is ablated by use of femtosecond laser with the on-target laser power at ˜5 mW (FIG. 2a). The micro-hole size determines the size and the shape of the air-cavity formed later;
(b) the first fiber tip with the micro-hole structure is spliced together with a cleaved single mode fiber (SMF) tip by use of fusion splicer with fusing current of 16.3 mA and fusing duration of 2.0 s. The two splicing parameters also play an important role in adjusting the size and the shape of the air-cavity;
(c) air in the micro-hole is suddenly heated causing the micro-hole to rapidly expand to form an elliptical air-cavity with a smooth surface called hollow sphere;
(d) the SMF fused with the first fiber having a hollow sphere is mounted between two translation stages and drawn into the microfiber by use of a flame brushing technique, i.e. to use a small flame moving under the fused microfiber as it is stretched. By appropriately controlling the speed of the flame and the holders, microfibers of different diameters can be produced, with an inner air-cavity along the fiber length.

Note that although cavity 30 is depicted in FIG. 2 as enclosing air, it can alternatively enclose various other materials such as other gases or liquids. Further, the hole can be coated with a thin layer of metal such as gold or silver after drawing. With a thin layer of metal on the surface of the air-cavity wall, a surface plasmon can be excited for photonic use.

The optical devices described above have a number of applications such as sensing applications. Below, detailed explanations of the fabrication and operation of these devices is provided.

### In-Line Mach-Zehnder Interferometer (MZI)

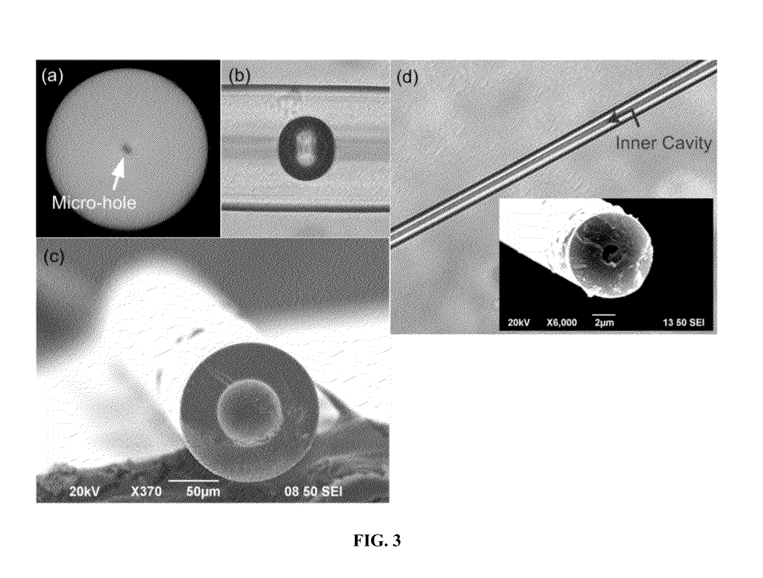

FIG. 3(a) shows the cleaved fiber end facet with a micro-hole fabricated by fs laser ablation. After fusion splicing with another section of single mode fiber (SMF), a hollow sphere-like void is formed in the SMF, its microscope side view and scanning electron-microscope (SEM) image of a cross section view are displayed in FIG. 3(b) and FIG. 3(c), respectively. The inner wall of the air-cavity is rather smooth, due to the high temperature experienced in the hollow sphere formation. FIG. 3(d) displays a microscopic side view and the SEM image of a cross section view of the microfiber with inner air-cavity which essentially forms a microfiber in-line MZI. The schematic diagram of the microfiber in-line MZI is illustrated in FIG. 1. In the tapered section, the input light beam is split into two portions denoted by I₁ and I₂ respectively. While I₁ travels along the silica cavity wall, I₂ propagates through the inner air-cavity, and the interference takes place when the two output beams recombine at the cavity end. The output intensity of the MZI is governed by:

$$I = {I}_{out 1} + {I}_{out 2} + 2 \sqrt{{I}_{out 1} {I}_{out 2}} cos ( \frac{2 π L Δ m}{λ} ) \qquad Eq . ( 1 )$$

where I represents the intensity of the interference signal, λ is the wavelength, L is the cavity length, Δn=n_{wall}−nₕₒₗₑ denotes the effective refractive index (RI) difference of the two interference arms, n_{wall} and nₕₒₗₑ are the effective RI of the silica wall mode and the air-cavity mode respectively. When the phase term satisfies the condition

$$\frac{2 π L Δ n}{λ} = ( 2 m + 1 ) π ,$$

where m is an integer, the intensity dip appears at the wavelength

$${λ}_{dip} = \frac{2 L Δ n}{2 m + 1} \qquad Eq . ( 2 )$$

### EXAMPLE 1

### Measurement of Refractive Index Change

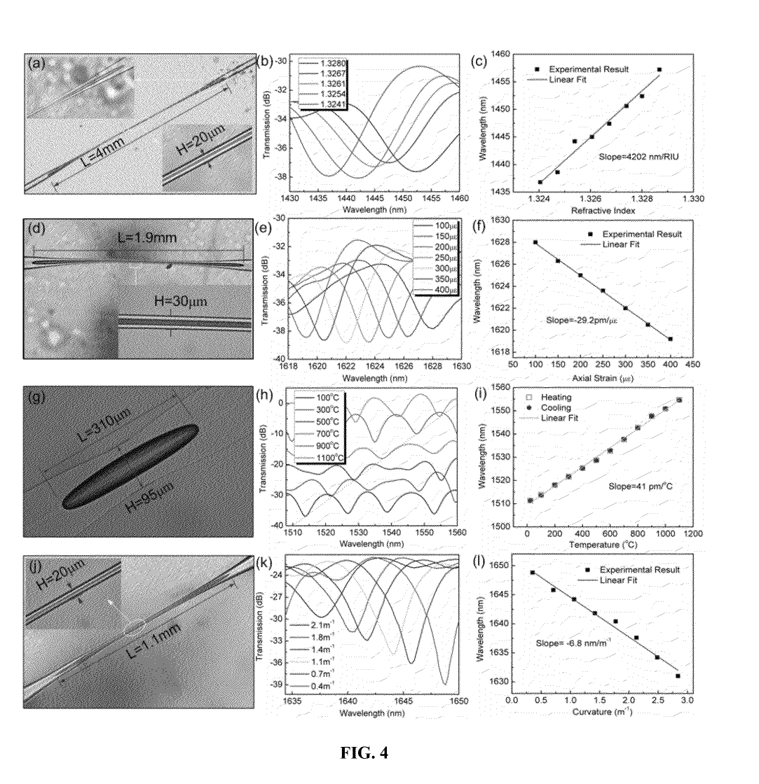

To test the system response to RI change, the device was immersed into the RI liquid (from Cargille Laboratories) with the RI value of 1.33 at room temperature and the temperature coefficient of 3.37×10⁻⁴/° C. The liquid RI value was changed by varying its temperature. The dip wavelength shift with the RI change can be derived from Eq. (2) as

$${δλ}_{dip} = \frac{2 ( L + δ {L}_{s} ) ( Δ n - δ {n}_{s} )}{2 m + 1} - \frac{2 L Δ n}{2 m + 1} \approx \frac{2 ( Δ n δ {L}_{s} - L δ {n}_{s} )}{2 m + 1} \qquad Eq . ( 3 )$$

where δn denotes the change in the effective RI of silica wall mode. FIG. 4(a) demonstrates the sample morphology in which the microfiber diameter is ˜20 μm, the air-cavity length and diameter are ˜4 mm and ˜4 μm, respectively, thus the thickness of the silica wall is ˜8 μm. The transmission spectra of the device corresponding to the RI value between 1.3241 and 1.3280 are plotted in FIG. 4(b) where a red shift of the dip wavelength shift can be observed. The variation of dip wavelength with different RI values is displayed in FIG. 4(c), where an extremely high sensitivity of ˜4202 nm/RIU (refractive index unit) is obtained, superior to most of the RI sensors. The RI sensitivity could be further enhanced by thinning the silica wall or increasing the interferometer cavity length. However, the increase of the cavity length would result in a large insertion loss and a reduced output fringe visibility.

### EXAMPLE 2

### Measurement of Strain

In the axial strain measurement, a 30 μm diameter microfiber with inner cavity of ˜1.9 mm in length and ˜12 μm in diameter as shown in FIG. 4(d) was fixed on two translation stages. The transmission spectra of the device corresponding to different strain values are displayed in FIG. 4(e) where a blue shift of fringe dip wavelength appears. FIG. 4(f) shows the variation of dip wavelength with the axial strain in the range between 0 to 400 με, where a high sensitivity of −29.2 pm/με can be obtained, which is close to 10 times that of standard fiber MZI, 30 times that of FBG and 3 times that of LPFG.

From Eq. (2), the wavelength shift due to the change of axial strain can be expressed as

$${δλ}_{dip} = \frac{2 ( L + δ {L}_{s} ) ( Δ n - δ {n}_{s} )}{2 m + 1} - \frac{2 L Δ n}{2 m + 1} \approx \frac{2 ( Δ n δ {L}_{s} - L δ {n}_{s} )}{2 m + 1} \qquad Eq . ( 3 )$$

where δLₛ is the change in cavity length and δnₛ denotes the change in the effective RI of the silica wall mode, induced by the increased axial strain. The experimental results obtained indicate that for the size of the microfiber and its inner cavity employed, the effective RI, δnₛ, plays the dominant role in determining the dip wavelength and a blue shift of dip wavelength corresponds to an increase of axial strain.

### EXAMPLE 3

### Measurement of Temperature Change

High temperature sensing capability of the device was investigated by use of a tube furnace (CARBOLITE MTF 12/38/250). FIG. 4(g) shows the microscopic image of the sample used, which has an inner cavity length and diameter of ˜310 μm and ˜50 μm, respectively, and a microfiber diameter of ˜95 μm. During the experiment, the sample was firstly heated to 1000° C. and maintained there for 2 hours to remove the burnt fiber coating induced effects and then cooled down to room temperature. Next, the temperature was gradually increased to 100° C., and then to 1100° C. with a step of 100° C., and stayed for half an hour at each step. The device was kept at 1100° C. for 2 hours before being cooling down, following the same steps as in the heating process.

FIG. 4(h) demonstrates the transmission spectra with offset at different temperatures. A fringe dip at ˜1510 nm at room temperature was found to experience a red shift with the increase of temperature. FIG. 4(i) presents the dip wavelength variation with the temperature change and the results obtained show that a good repeatability in both heating and cooling processes and a high sensitivity of 41 pm/° C. can be achieved. The wavelength shift due to temperature increase can be expressed as

$${δλ}_{dip} = \frac{2 ( L + δ {L}_{T} ) ( Δ n + δ {n}_{T} )}{2 m + 1} - \frac{2 L Δ n}{2 m + 1} \approx \frac{2 ( Δ n δ {L}_{T} + L δ {n}_{T} )}{2 m + 1}$$

where δL_{T} is the change of inner cavity length induced by material thermal-expansion and δn_{T} denotes the change in effective RI of the silica wall mode, due to thermal-optical effect. The thermal-optical effect plays the dominant role as the thermo-optic coefficient (7.8×10⁻⁶) in silica is larger than thermal expansion coefficient (4.1×10⁻⁷).

### EXAMPLE 4

### Bend Measurement

FIG. 4(j) shows the microscopic image of the sample used in the bending measurement, in which the microfiber diameter is ˜20 μm and the inner cavity length and diameter are ˜1.1 mm and ˜7 μm, respectively. The spectra obtained at different curvatures are shown in FIG. 4(k), where the fringe contrast becomes degraded with the increase of curvature, due to the increased cavity-mode loss. The blue shift of the fringe dip can be explained by the increased effective RI of the silica wall mode owing to the elastic-optic effect. The wavelength shift versus curvature change is shown in FIG. 4(l), where a high sensitivity of −6.8 nm/m⁻¹ is obtained.

### EXAMPLE 5

### Two Fiber Sensor System

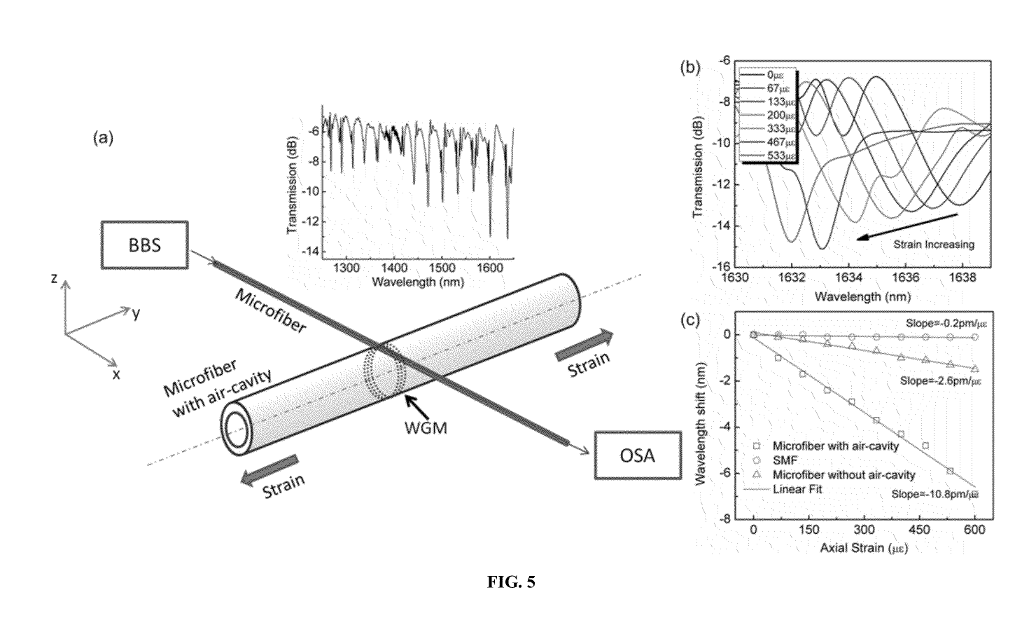

FIG. 5(a) illustrates a strain measurement system including an optical sensor 10 with an inner cavity 30. Light is evanescently coupled in the sensor 10 by a second microfiber 50 perpendicularly crossing and in intimate contact with cavity-containing microfiber 10. The second microfiber 60 optically communicates with a broadband source (BBS) and an optical spectrum analyzer (OSA) with the resolution of 10 pm. A spectrum corresponding to the microfiber 10 having a diameter of ˜16 μm and cavity wall 20 thickness of ˜2 μm is displayed in the inset of FIG. 5(a) where the line width at the dip wavelength of ˜1636 nm is ˜3.4 nm, which gives a quality factor of ˜480.

FIG. 5(b) shows the spectra obtained at different axial strain values, and a blue shift of the dip wavelength can be observed. For the dip wavelength at ˜1636 nm, its variation with axial strain corresponding to the device 10, a 16 μm diameter microfiber without inner air-cavity and a 16 μm diameter microfiber with inner air-cavity are demonstrated in FIG. 5(c) where the sensitivity values obtained are −0.2, −2.6 and −10.8 pm/με, respectively, which reveals the high potential of the microfiber with inner air-cavity in strain sensing.

As shown in the above embodiments, by fabricating an air-cavity inside a microfiber, a variety of optical sensors can be formed. In particular an extremely small fiber interferometer can be created. In such a device, the unique features of microfibers are effectively used to create highly sensitive Mach-Zehnder interferometers or multiple fiber sensor systems, thus providing versatile optical fiber sensing applications.

### EXAMPLE 6

### Polarization Maintaining Fiber with Two Parallel Inner Air-Cavities

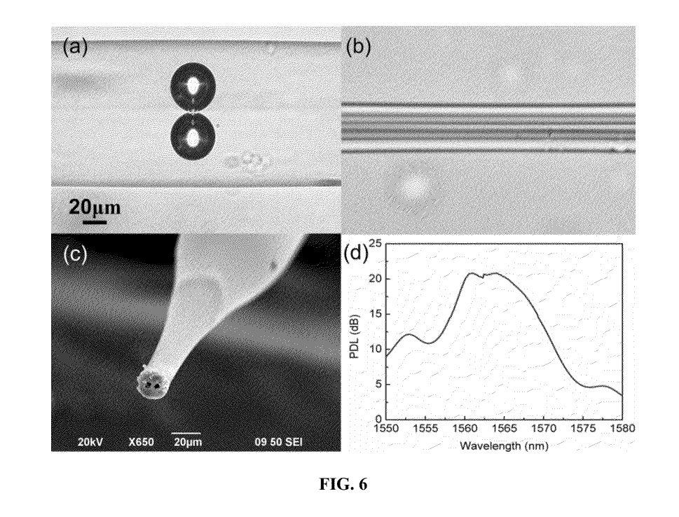

A modified device configuration with two parallel inner air-cavities is created in microfiber for polarization maintaining (PM) fiber use. Initially, femtosecond laser is used to ablate two similar-size holes of ˜15 μm in diameter and ˜100 μm in depth. Both holes are ˜25 μm distance away from the fiber core and positioned in symmetry. After being splicing with another cleaved SMF tip with fusing current of 17.0 mA and fusing duration of 2.2 s, two parallel inner air-cavities with similar size and shape are simultaneously formed, as shown FIG. 6(a). After a heating and pulling process, the microfiber of ˜19 μm in diameter, with two inner air-cavities of similar size are fabricated and FIG. 6(b) displays a microscope side-view of the device. The SEM image of the cross section view of the device is revealed in FIG. 6(c) where the micro-hole diameter can be determined as ˜4 μm. Such configuration is similar to a “Panda” PM optical fiber in structure.

The polarization dependent loss (PDL) of such microfiber device is measured by an Agilent 81910A photonic all-parameter analyzer. In FIG. 6(d), a PDL of above of 10 dB over a wavelength of wider than 20 nm (from 1,551 nm to 1,572 nm) is achieved. The PDL of the original SMF is negligible and the large PDL should come from the stress induced in the core region via two symmetrical air-cavities within the silica cladding. This indicates that such a configuration could be used as a promising PM microfiber.

### EXAMPLE 7

### Microfiber with Deviated Air-Cavity

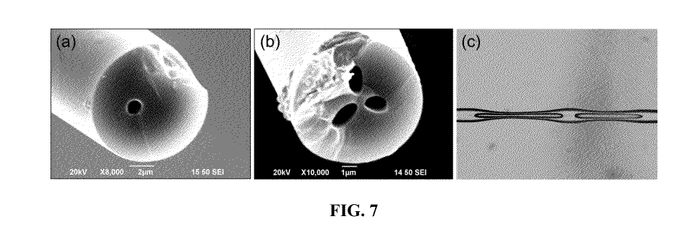

In FIG. 7(a), the microfiber device is configured to have a deviated air-cavity. The diameter of the air-cavity is as small as ˜1.5 μm over the uniform waist region of the microfiber. The characteristics of the air-cavity including the size, shape and position are all adjustable in this technique and one possible application of this configuration is to operate as a mode converter.

### EXAMPLE 8

### Non-Linear Optics Applications with Three Air-Cavities Structure

In FIG. 7(b), the microfiber device is configured to have three symmetrical air-cavities surrounding the central axis of the microfiber. It can be clearly seen that the central region is submicron in diameter, which might have potential in nonlinear optics applications.

### EXAMPLE 9

### Cascaded Microfiber with Inner Air-Cavity

FIG. 7(c) is a photomicrograph of a cascaded microfiber with inner air-cavity. It is known that by cascading the fiber MZIs, the bandwidth of the output spectrum can be further widened and the extinction ratio of the device will be enhanced. Thus, it will be an easy way to adjust the output spectrum by cascading a number of such microfiber MZIs with suitable size.

While the foregoing invention has been described with respect to various embodiments, such embodiments are not limiting. Numerous variations and modifications would be understood by those of ordinary skill in the art. Such variations and modifications are considered to be included within the scope of the following claims.

What is claimed is:

1. An in-line optical microfiber device comprising:
an optical microfiber;
at least one enclosed cavity positioned completely within the optical microfiber, such that an input light beam travelling within the optical microfiber is split into two portions and said two portions pass through the at least one enclosed cavity and a remaining portion of the optical microfiber that is not occupied by the enclosed cavity, respectively, the two portions of light being recombined after passing through the enclosed cavity and the remaining portion of the optical microfiber such that the recombined light is correlated to an external physical property to be measured.

2. The in-line optical microfiber device according to claim 1 wherein each of the at least one enclosed cavity is positioned along a central axis of the microfiber.

3. The in-line optical microfiber device according to claim 1 wherein at least one enclosed cavity is positioned off-center with respect to a central axis of the microfiber.

4. The in-line optical microfiber device according to claim 1 further comprising:
a second optical fiber positioned adjacent to the optical microfiber such that light travelling in the second optical microfiber is evanescently coupled into the at least one enclosed cavity formed within the optical microfiber.

5. The in-line optical microfiber device according to claim 3 wherein the optical microfiber is configured such that the recombined light intensity is related to a surrounding temperature or refractive index to measure temperature or refractive index.

6. The in-line optical microfiber device according to claim 2 wherein the optical microfiber is configured such that strain is measured based on whispering gallery mode (WGM) resonator properties of said enclosed cavity.

7. A method for making the in-line optical microfiber device of claim 1 comprising:
providing a first optical fiber having a cladding layer and a core layer;
cleaving the first optical fiber to expose an end surface thereof;
micromachining a microhole either completely or partially positioned within the core layer, or adjacent to the core layer of the exposed end surface of the first optical fiber;
providing a second optical fiber having a cladding layer and a core layer;
cleaving the second optical fiber to expose an end surface thereof;
fusing the end surface of the first optical fiber having the microhole formed therein to the end surface of the second optical fiber;
heating the microhole to form a hollow sphere and drawing the fused first and second optical fibers to form a microfiber region, the microfiber region including an elongated cavity formed from the hollow sphere.

8. A method for making the in-line optical microfiber device according to claim 7 wherein the micromachining is formed by a laser.

9. A method for making the in-line optical microfiber device according to claim 8 wherein the laser is a pulsed laser.

10. A method for making the in-line optical microfiber device according to claim 9 wherein the pulsed laser is a femtosecond pulsed laser.

11. A method for making the in-line optical microfiber device according to claim 7 further comprising forming plural microholes to form plural elongated optical cavities.

12. A method for making the in-line optical microfiber device according to claim 7 wherein three microholes are formed adjacent to the core such that the formed microfiber device after drawing has three symmetrical cavities surrounding a central axis of the microfiber.

13. The microfiber device formed according to the process of claim 12.

14. A method for making the in-line optical fiber device of claim 7 wherein the micro-hole is positioned such that a deviated elongated cavity is formed following drawing.

15. The in-line optical fiber device formed according to the process of claim 14.

16. The in-line optical microfiber device of claim 1 further comprising:
at least one additional enclosed cavity positioned completely within the optical microfiber downstream of a first enclosed cavity such that the recombined light from the first optical cavity is the input light for the additional enclosed cavity such that the recombined light beam is split into two portions and said two portions pass through the additional enclosed cavity and a remaining portion of the optical microfiber that is not occupied by the enclosed cavity, respectively, the two portions of light being recombined after passing through the additional enclosed cavity and the remaining portion of the optical microfiber such that the recombined light after the additional enclosed cavity is correlated to an external physical property to be measured.
